(19) United States
(12) Patent Application Publication
(10) Pub. No.: US 2024/0292487 A1
(43) Pub. Date: Aug. 29, 2024

(54) INFORMATION PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Yanhua LI, Beijing (CN)

(73) Assignee: Beijing Xiaomi Mobile Software Co., Ltd., Beijing (CN)

(21) Appl. No.: 18/571,079

(22) PCT Filed: Jun. 18, 2021
(86) PCT No.: PCT/CN2021/101002

§ 371 Date: Dec. 15, 2023

(51) Int. Cl. H04W 76/28

(52) U.S. Cl. CPC H04W 76/28

(57) ABSTRACT

An information processing method, a user equipment (UE) and base station that improve the utilization of a wireless network. The utilization is improved by: reporting extended discontinuous reception (eDRX) ability information of the UE, where the eDRX ability information is used by a network to determine a minimum eDRX cycle supported by the UE.

### CROSS-REFERENCE TO RELATED APPLICATION

The present application is a U.S. National Stage of International Application No. PCT/CN2021/101002, filed on Jun. 18, 2021, the contents of all of which are incorporated herein by reference in their entireties for all purposes.

### BACKGROUND

User equipment (UE) has to balance low power consumption and services requiring low latency. In each extended discontinuous reception (eDRX) cycle, the UE can receive downlink data only in a set paging time window (PTW), and does not receive downlink data for the rest of the time during which a terminal is in a sleep mode. Through such an eDRX mode, the latency of downlink service and power consumption will be balanced. For example, a gas service is remotely stopped by a specific intelligent terminal. In a case that the specific intelligent terminal is in the eDRX mode, its power consumption can be reduced as much as possible while services are implemented.

Each eDRX cycle longer than a certain duration can be provided with one PTW, and the UE can monitor a paging channel in the PTW according to a discontinuous reception (DRX) cycle in order to receive downlink data, and the terminal is in a sleep mode for the rest of time.

### SUMMARY

The disclosure relates to, but is not limited to, the technical field of wireless communication, and in particular relates to an information processing method and apparatus, a communication device, and a storage medium.

A first aspect of the examples of the disclosure provides an information processing method. The method is executed by a user equipment (UE) and includes: reporting extended discontinuous reception (eDRX) ability information of the UE, where the eDRX ability information is used by a network to determine a minimum eDRX cycle supported by the UE.

A second aspect of the examples of the disclosure provides an information processing method. The method is executed by a network device and includes: receiving extended discontinuous reception (eDRX) ability information of a UE, where the eDRX ability information is used by a network to determine a minimum eDRX cycle supported by the UE.

A third aspect of the examples of the disclosure provides an information processing apparatus. The apparatus includes: a reporting module configured to report extended discontinuous reception (eDRX) ability information of a UE, where the eDRX ability information is used by a network to determine a minimum eDRX cycle supported by the UE.

A fourth aspect of the examples of the disclosure provides an information processing apparatus. The apparatus includes: a receiving module configured to receive extended discontinuous reception (eDRX) ability information of a UE, where the eDRX ability information is used by a network to determine a minimum eDRX cycle supported by the UE.

A fifth aspect of the examples of the disclosure provides a communication device, including a processor, a transceiver, a memory, and an executable program stored in the memory and executable by the processor. The processor executes the information processing method according to the first aspect or the second aspect when running the executable program.

A sixth aspect of the examples of the disclosure provides a non-transitory computer storage medium. The non-transitory computer storage medium stores an executable program, and the executable program may implement the information processing method according to the first aspect or the second aspect after being executed by a processor.

### BRIEF DESCRIPTION OF THE DRAWINGS

The drawings here are incorporated in the description as a constituent part of the description, illustrate examples conforming to the disclosure, and serve to explain principles of the disclosure along with the description.

FIG. 1 is a schematic structural diagram of a wireless communication system according to an example;

FIG. 2 is a timing diagram illustrating the execution of an extended discontinuous reception (eDRX) function according to an example;

FIG. 3 is a schematic diagram illustrating interaction generated when a core network configures an idle-state eDRX function according to an example;

FIG. 4 is a flowchart of an information processing method according to an example;

FIG. 5 is a flowchart of an information processing method according to an example;

FIG. 6 is a flowchart of an information processing method according to an example;

FIG. 7 is a schematic structural diagram of an information processing apparatus according to an example;

FIG. 8 is a schematic structural diagram of an information processing apparatus according to an example;

FIG. 9 is a schematic structural diagram of a user equipment (UE) according to an example; and

FIG. 10 is a schematic structural diagram of a communication device according to an example.

### DETAILED DESCRIPTION

Description will be made in detail to examples here, instances of which are illustrated in the accompanying drawings. When the following description relates to the accompanying drawings, the same numbers in different accompanying drawings refer to the same or similar elements unless otherwise indicated. The embodiments described in the following examples do not represent all embodiments consistent with the examples of the disclosure. Rather, they are merely instances of apparatus and methods consistent with some aspects of the examples of the disclosure as described in detail in the appended claims.

The term used in the examples of the disclosure is for the purpose of describing particular examples merely and is not intended to limit the examples of the disclosure. As used in the examples and the appended claims of the disclosure, singular forms “a,” “an,” and “the” are intended to include plural forms as well, unless otherwise clearly indicated in the context. It should be understood that the term “and/or” as used in the examples of the disclosure, refers to and encompasses any or all possible combinations of one or more of associated listed items.

It should be understood that although the terms first, second, third, etc., may be employed in the examples of the disclosure to describe various information, such information should not be limited to these terms. These terms are used to distinguish the same type of information from each other. For example, first information may also be referred to as second information, and similarly, second information may also be referred to as first information, without departing from the scope of the examples of the disclosure. The word “if” as used here may be construed to mean “at the time of,” “when” or “in response to determining”, depending on the context.

With reference to FIG. 1, a structural schematic diagram of a wireless communication system provided in an example of the disclosure is shown. As shown in FIG. 1, the wireless communication system is a communication system based on a cellular mobile communication technology. The wireless communication system may include several UEs 11 and several access devices 12.

The UE 11 may be a device that provides voice and/or data connectivity for a user. The UE 11 may communicate with one or more core networks by means of a radio access network (RAN). The UE 11 may be an Internet of Things UE, for example, a sensor device, and a mobile telephone (or referred to as a “cellular” telephone), and a computer having an Internet of Things UE, for example, a stationary, portable, pocket-sized, hand-held, computer-built, or vehicle-mounted apparatus. For example, the UE 11 may be a station (STA), a subscriber unit, a subscriber station, a mobile station, a mobile, a remote station, an access point, a remote terminal, an access terminal, a user terminal, a user agent, a user device, or a user equipment (UE). Alternatively, the UE 11 may also be a device of an unmanned aerial vehicle. Alternatively, the UE 11 may also be a vehicle-mounted device, for example, a trip computer having a wireless communication function, or a wireless communication device externally connected to the trip computer. Alternatively, the UE 11 may also be a roadside device, for example, a street lamp, a signal lamp, another roadside device, etc. with the wireless communication function.

The access device 12 may be a network device in the wireless communication system. The wireless communication system may be the 4th generation mobile communication (4G) system, also referred to as a long term evolution (LTE) system. Alternatively, the wireless communication system may also be a 5G system, also referred to as a new radio (NR) system or a 5G NR system. Alternatively, the wireless communication system may also be a next generation system consecutive to the 5G system. An access network in the 5G system may be referred to as a new generation-radio access network (NG-RAN). Alternatively, the wireless communication system may be a machine-type communication (MTC) system.

The access device 12 may be an evolved Node B (eNB) used in a 4G system. Alternatively, the access device 12 may also be a next-generation Node B (gNB) using a central-distributed architecture in a 5G system. In a case that the access device 12 adopts the central-distributed architecture, the access device 12 generally includes a central unit (CU) and at least two distributed units (DUs). The central unit is provided with protocol stacks of a packet data convergence protocol (PDCP) layer, a radio link control (RLC) layer and a media access control (MAC) layer. Each distributed unit is provided with a protocol stack of a physical (PHY) layer. A specific implementation of the access device 12 is not limited in the examples of the disclosure.

A radio connection may be established between the access device 12 and the UE 11 by means of radio air interfaces. In different embodiments, the radio air interface is a radio air interface based on a 4th generation mobile communication network technology (4G) standard; alternatively, the radio air interface is a radio air interface based on a 5th generation mobile communication network technology (5G) standard. For example, the radio air interface is a new radio. Alternatively, the radio air interface may also be a radio air interface based on a 5G-based next generation mobile communication network technology standard.

In some examples, an end to end (E2E) connection may also be established between the UEs 11, for example, vehicle to vehicle (V2V) communication, vehicle to infrastructure (V2I) communication, vehicle to pedestrian (V2P) communication, etc. in vehicle to everything (V2X) communication.

In some examples, the above wireless communication system may further include a network management device 13.

The several access devices 12 are each connected to the network management device 13. The network management device 13 may be a core network device in the wireless communication system. For example, the network management device 13 may be a mobility management entity (MME) in an evolved packet core (EPC). Alternatively, the network management device may be another core network device, for example, a serving gateway (SGW), a public data network gateway (PGW), a policy and charging rules function (PCRF), a home subscriber server (HSS), etc. The examples of the disclosure do not limit an implementation form of the network management device 13.

The UE enables an eDRX function and enters an eDRX mode. The UE in the eDRX mode has the following features: the UE is reachable at any time. However, a latency for reachability is large and depends on the configuration of the eDRX cycle.

In this way, the UE with the eDRX function enabled achieves the maximum balance between power consumption of the UE and the timeliness of data transmission.

The eDRX function has one or more of the following eDRX parameters:
a starting time domain position of a paging time window (PTW);
a length of the PTW; and
an eDRX cycle which may be denoted by T_{eDRX,H}.

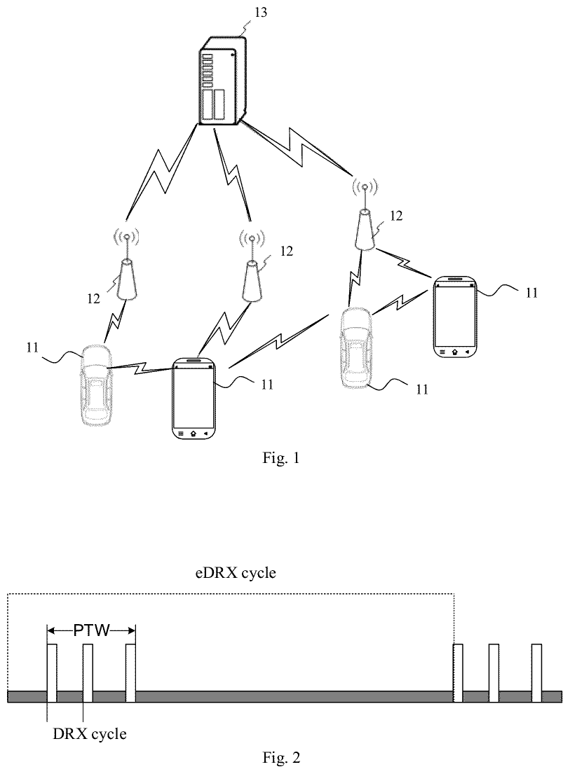

FIG. 2 shows a timing diagram after the UE enables the eDRX function.

With reference to FIG. 2, it can be seen that there has a PTW in one eDRX cycle and there has one or more DRX cycles in one PTW.

Duration of a DRX cycle may be much shorter than duration of an eDRX cycle.

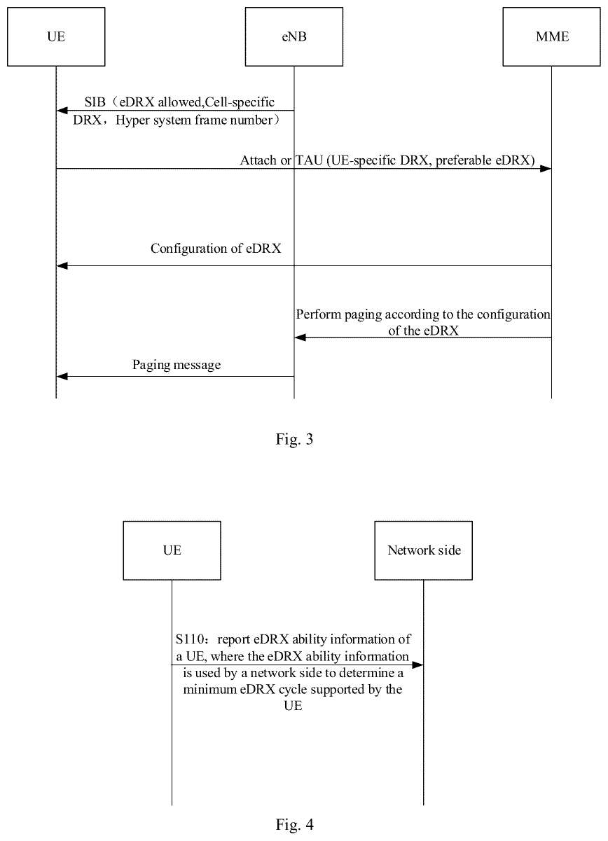

FIG. 3 shows one type of eDRX parameters for interaction of the eDRX function between the UE and a core network.

It needs to be noted that in a case that the eDRX cycle is longer than 10.24 s, a PTW may be set in the eDRX cycle.

A method for interaction of the eDRX parameters between the UE and the core network as shown in FIG. 3 may include:
an eNB transmits an indication of an allowed eDRX function, a cell-specific DRX indication, and a hyper system frame number (SFN) to the UE by means of a system information block (SIB);
the UE transmits at least one of a UE-specific DRX parameter or a preferable DRX parameter (preferable eDRX) in an attach request or a tracking area update (TAU) request;
after receiving the attach request or the TAU request, an MME issues eDRX configuration to the UE, where the eDRX configuration carries one or more of the foregoing eDRX parameters;
the MME performs paging according to the eDRX configuration; and
after receiving a core network (CN) paging message issued by the MME, the eNB forwards the CN paging message to the UE.

The eDRX parameters issued by a core network are transparently transmitted to the UE by means of a base station (for example, an evolved Node B (eNB) or a next generation Node B (gNB)). For example, the mobile management entity (MME) of the core network transmits the eDRX parameters of the eDRX function to the UE by means of the eNB.

A radio resource control (RRC) idle state, an idle state for short, is a low power consumption state of the UE that is known to the core network.

An RRC inactive state is called an inactive state for short. The inactive state is a low power consumption state of the UE transparent to the core network. However, the inactive state is visible to an access network.

In a case that the UE enters the inactive state, the UE needs to receive a paging message transmitted from a CN (that is, a CN paging message), and also needs to receive a paging message transmitted from a radio access network (RAN), that is, an RAN paging message.

As shown in FIG. 4, an example of the disclosure provides an information processing method. The method is executed by a UE and includes step S110.

Step S110 includes reporting eDRX ability information of the UE, where the eDRX ability information is used by a network to determine a minimum eDRX cycle supported by the UE.

The method may be executed by the UE. The UE may be various types of UE. Typical UE includes, but is not limited to, mobile phones, tablet computers, wearable devices, vehicle-mounted devices, Internet of Things devices, smart home devices, smart office devices, smart teaching devices, or mobile robots, etc. . . .

The UE in the eDRX mode includes, but is not limited to, at least one of an idle-state UE or an inactive-state UE. The idle-state UE is in an idle state, and the inactive-state UE is in an inactive state.

An eDRX cycle corresponding to the eDRX mode of the idle-state UE is referred to as an idle-state eDRX cycle. An eDRX cycle corresponding to the eDRX mode of the inactive-state UE is referred to as an inactive-state eDRX cycle.

The eDRX cycle includes, but is not limited to, one of the following cycles: 2.56 s, 5.12 s, 10.24 s, and cycles longer than 10.24 s. The cycles longer than 10.24s may include, but are not limited to, 20.48 s, etc.

Illustratively, the eDRX mode has a plurality of eDRX cycles. The minimum eDRX cycle in the eDRX mode may be determined according to duration. Taking the above eDRX cycles as examples, the minimum eDRX cycle in the eDRX mode is 2.56 s.

In another example, the UE reports whether the UE supports the minimum eDRX cycle in the eDRX mode by means of the eDRX ability information according to whether the UE supports the minimum eDRX cycle of the eDRX mode.

In an example, the UE reports the minimum eDRX cycle supported by the UE by means of the eDRX ability information according to an eDRX mode supported by the UE.

The eDRX ability information may include at least one of:
duration information of the minimum eDRX cycle, for indicating duration of the minimum eDRX cycle;
an identifier of the minimum eDRX cycle supported by the UE, where one identifier corresponds to one eDRX cycle; or
an indication bit, for indicating whether the UE supports a minimum eDRX cycle of an eDRX mode for all communication devices. Two bit values of the indication bit may respectively indicate that the minimum eDRX cycle of the eDRX mode is supported or is not supported. For example, the eDRX mode has a plurality of eDRX cycles, and each cycle corresponds to one bit. According to a negotiation agreement, the UE may set a corresponding bit to be a specific value, to indicate whether the UE supports the corresponding eDRX cycle.

In an example, eDRX cycle information alone may occupy one or more bits to explicitly indicate the minimum eDRX cycle supported by the UE. In another example, the eDRX cycle information may also have a corresponding relationship with other information, and share one or more indication bits with other information, that is, the minimum eDRX cycle supported by the UE is implicitly indicated.

The minimum eDRX cycle may include at least one of a minimum idle-state eDRX cycle or a minimum inactive-state eDRX cycle.

Minimum eDRX cycles supported by different UEs may be the same or not.

In an example, the minimum idle-state eDRX cycle and the minimum inactive-state eDRX cycle may be equal or not.

In an example, the UE may share the same eDRX cycle in the idle state and the active state, and the UE may not share the same eDRX cycle in the idle state and the active state. The UE reports the minimum eDRX cycle supported by the UE, then the network will know the eDRX cycle supported by the UE, and subsequently the network may configure an appropriate eDRX cycle for the UE according to the eDRX cycle supported by the UE. Thus, the problem that the UE does not support the eDRX cycle caused by the fact that the network does not know the minimum eDRX cycle supported by the UE or the problem that the configured eDRX cycle is too long to satisfy current service requirements of the UE caused by the fact that the network does not know the minimum eDRX cycle supported by the UE are reduced.

In an example, the UE reports the minimum eDRX cycle supported by the UE to at least one of the base station or the core network device.

There are many occasions for the UE to report the minimum eDRX cycle supported by the UE. In an example, the UE reports the minimum eDRX cycle at initial access, random access, or attaching, or tracking area update or notification area update.

In an example, the eDRX ability information includes at least one of:
first ability information indicating a minimum idle-state eDRX cycle supported by the UE; or,
second ability information indicating a minimum inactive-state eDRX cycle supported by the UE.

In this way, the UE may report the eDRX cycle supported by the UE in at least one of the idle state or the inactive state to the network by means of the first ability information and the second ability information respectively, that is, report the idle-state eDRX cycle and the inactive-state eDRX cycle by means of the first ability information and the second ability information respectively.

In another example, only one eDRX cycle is reported in the eDRX cycle information, and the eDRX cycle may be the minimum idle-state eDRX cycle supported by the UE by default.

In another example, only one eDRX cycle is reported in the eDRX cycle information, and the eDRX cycle may be the minimum inactive-state eDRX cycle supported by the UE by default.

In another example, only one eDRX cycle is reported in the eDRX cycle information, and the eDRX cycle may be the minimum idle-state eDRX cycle supported by the UE and may also be the minimum inactive-state eDRX cycle supported by the UE by default.

In summary, there are many ways for the UE to report the eDRX ability information for the minimum eDRX cycle supported by the UE, which are not limited to any of the above.

In an example, step S110 may include:
reporting UE ability information indicating the eDRX ability information to a base station; or,
reporting auxiliary information indicating the eDRX ability information to a base station.

The UE ability information may be signaling for the UE to report its various aspects of ability information. In an example, the UE ability information may be used to report the eDRX ability information corresponding to the minimum eDRX cycle supported by the UE and may further be used to report information such as whether the UE supports an eDRX mode or whether the UE supports a band width part (BWP).

The UE may also report some self-ability related or expected network configuration and the like by means of the auxiliary information. In the examples of the disclosure, the eDRX ability information may also be carried in the auxiliary information.

Both the UE ability information and the auxiliary information may be information or signaling provided in the related art. Thus, in the examples of the disclosure, the eDRX ability information may be carried in the UE ability information or the auxiliary information and reported without setting dedicated signaling or message, which has high compatibility with the related art.

The UE reports the eDRX ability information to the base station, and the minimum eDRX cycle determined by the base station according to the eDRX ability information may be used by the base station to configure the inactive-state eDRX cycle. For example, at least after receiving the eDRX ability information of the UE, the base station may determine the minimum eDRX cycle supported by the UE, and then configure the eDRX cycle in the inactive state for the UE according to the minimum eDRX cycle.

In an example, the eDRX ability information reported to the base station may be a minimum inactive-state eDRX cycle supported by the UE. The minimum inactive-state eDRX cycle is used by the base station to configure an inactive-state eDRX cycle for the UE.

In another example, S110 may include one of the following:
reporting a UE ability information notification indicating the eDRX ability information to a core network; or, reporting a non-access stratum (NAS) message indicating the eDRX ability information to a core network.

In some examples, the eDRX ability information is reported to the core network, that is, reported to the core network device. In an example, the eDRX ability information is reported to an access management function (AMF) or a session management function or a user plane function (UPF) of the core network.

When the eDRX ability information is reported to the core network device, the eDRX ability information may be carried in the UE ability information notification, or carried in the NAS message. In this way, the eDRX ability information is reported without specially setting dedicated signaling, which has high compatibility with the related art.

In some examples, the eDRX ability information may also be carried in dedicated signaling and reported, to reduce the complexity of decoding at the network.

In an example, the eDRX ability information reported to the base station may be the minimum idle-state eDRX cycle supported by the UE. The minimum idle-state eDRX cycle is used by the core network to configure an idle-state eDRX cycle for the UE.

An example of the disclosure provides an information processing method. The method may include: determining a minimum eDRX cycle supported by a base station.

The method may be executed by a UE. The minimum eDRX cycle supported by the base station includes, but is not limited to, at least one of a minimum idle-state eDRX cycle supported by the base station or a minimum inactive-state eDRX cycle supported by the base station.

The minimum eDRX cycle supported by the base station facilitates determination of the eDRX cycle by the UE used during monitoring of paging messages in the eDRX mode.

In an example, determining the minimum eDRX cycle supported by the base station includes one of the following:
receiving indication information, where the indication information indicates at least one of a minimum inactive-state eDRX cycle or a minimum idle-state eDRX cycle supported by the base station; and
determining at least one of the minimum inactive-state eDRX cycle or the minimum idle-state eDRX cycle supported by the base station according to a protocol agreement.

The base station may indicate the minimum eDRX cycle supported by the base station. Alternatively, the minimum eDRX cycle supported by the base station may be determined according to the protocol agreement or based on pre-configuration of the UE.

There are many ways for the UE to determine the minimum eDRX cycle supported by the base station, which are not limited to any of the above.

For example, the base station issues indication information to inform the UE of the minimum eDRX cycle supported, which may trigger the UE to report the eDRX ability information. Alternatively, the UE may also report the eDRX ability information autonomously.

For another example, the UE reports whether the UE supports the minimum eDRX cycle in a case that the indication information issued by the base station indicates that the base station presets an eDRX cycle. For example, in a case that the preset eDRX cycle is the minimum cycle of the eDRX mode, that is, the minimum eDRX cycle, the UE reports the eDRX ability information of whether the UE supports the minimum eDRX cycle. Alternatively, the UE may report the eDRX ability information autonomously according to service requirements of the UE and eDRX parameters expected by the UE in the eDRX mode.

For example, an information indication mode of the indication information may be the same as a mode of the UE to report the eDRX ability information, or the information indication mode of the indication information may be different from the mode of the UE to report the eDRX ability information. For example, the indication information may indicate whether the base station supports the minimum eDRX cycle of the eDRX mode, or directly indicate the minimum eDRX cycle supported by the base station.

In an example, the indication information is carried in common signaling or dedicated signaling.

The common signaling includes, but is not limited to, a system message or downlink control information (DCI).

In a case that the common signaling is used for issuing the indication information, a plurality of UEs can monitor the indication information issued by the base station. In a case that the dedicated signaling is used for issuing the indication information, only a specific UE can monitor the indication information issued by the base station.

For example, the dedicated signaling may be any unicast signaling for interaction between the network and the UE. The unicast signaling includes, but is not limited to, various RRC signaling, such as RRC release signaling or RRC connection establishment signaling.

In an example, the method further includes one of the following:
monitoring, in response to determining that the UE is in the idle state and the idle-state eDRX cycle is configured as a first cycle, a paging message according to the first cycle, where the first cycle is the minimum eDRX cycle of the eDRX mode;
monitoring, in response to determining that the UE is in the inactive state, the idle-state eDRX cycle of the UE is configured as a first cycle and the inactive-state eDRX cycle of the UE is not configured as the first cycle, a paging message according to the first cycle;
monitoring, in response to determining that the UE is in the inactive state, the idle-state eDRX cycle of the UE is configured as a first cycle and the inactive-state eDRX cycle of the UE is not configured as the first cycle, a paging message according to a shorter one of the first cycle and a second cycle;
monitoring, in response to determining that the UE is in the inactive state, the idle-state eDRX cycle of the UE is configured as a first cycle, and the inactive-state eDRX cycle of the UE is not configured as the first cycle, a paging message according to the minimum inactive-state eDRX cycle supported by the base station; or
monitoring, in response to determining that the UE is in the inactive state and the inactive-state eDRX cycle of the UE is configured as a first cycle, a paging message according to an idle-state eDRX cycle configured for the UE by the network.

In an example, both the idle-state eDRX cycle and the inactive-state eDRX cycle of the UE may be configured by the network. For example, the idle-state eDRX cycle of the UE may be configured by the core network, and the inactive-state eDRX cycle may be configured by an access network (for example, base station). For another example, both the idle-state eDRX cycle and the inactive-state eDRX cycle of the UE may be configured by any one of the core network or the access network at the network.

That is, the idle-state eDRX cycle of the UE is configured to be the minimum eDRX cycle of the eDRX mode, and the UE may monitor at least one of core network paging or radio access network paging of the base station according to the minimum eDRX cycle (that is, the first cycle). In this case, the UE is in the idle state, and the UE only receives paging from the core network normally, such that the UE may monitor the core network paging according to the first cycle. For the UE, no matter whether monitoring corresponds to core network paging or radio access network paging, the UE receives a paging message from the network.

In an example, the UE is in the inactive state, and the UE normally only receives paging from the base station and does not monitors paging from the core network, but in an abnormal case (for example, the core network loses the context of the UE), the UE may still monitor paging from the core network. In a case that the UE is in the inactive state, the network configures the first cycle as the idle-state eDRX cycle of the UE instead of the inactive-state eDRX cycle, and the UE may monitor a paging message directly according to the first cycle. In this way, the UE is easy to implement.

In an example, the UE is in the inactive state and the network configures the minimum eDRX cycle (for example, 2.56 s) of the eDRX mode as the idle-state eDRX cycle of the UE instead of the inactive-state eDRX cycle, and a paging message is monitored according to a shorter one of the first cycle and a second cycle, where the second cycle is a RAN paging cycle. That is, in a case that the RAN paging cycle is shorter than the first cycle, the paging message is monitored according to the RAN paging cycle. In a case that the RAN paging cycle is longer than the first cycle, the paging message is monitored according to the first cycle.

In another example, the UE is in the inactive state, the network configures the first cycle as the idle-state eDRX cycle of the UE instead of the inactive-state eDRX cycle, and the UE monitors a paging message according to the minimum eDRX cycle supported by the base station, such that a phenomenon of wasting power consumption caused by monitoring according to the first cycle is reduced at least in a case that the base station does not support the minimum eDRX cycle of the eDRX mode.

In view of this, in some examples, monitoring the paging message according to the minimum inactive-state eDRX cycle supported by the base station includes one of the following:
monitoring, in response to determining that the base station supports the inactive-state eDRX cycle as the first cycle, the paging message according to the first cycle; or
monitoring, in response to determining that the base station does not support the inactive-state eDRX cycle as the first cycle, the paging message according to a shorter one of the first cycle and a second cycle, where the second cycle is a radio access network (RAN) paging cycle.

In a case that the UE is in the inactive state and the inactive-state eDRX cycle of the UE is also configured as the first cycle, the cycle of the UE monitoring the paging message may be determined according to the idle-state eDRX cycle of the UE.

In an example, monitoring, in response to determining that the UE is in the inactive state and the inactive-state eDRX cycle of the UE is configured as the first cycle, the paging message according to the idle-state eDRX cycle configured for the UE by the network includes one of the following:
monitoring the paging message according to the first cycle in response to determining that the idle-state eDRX cycle of the UE is configured to be within a preset multiple of the first cycle;
monitoring, outside a paging time window (PTW) of an idle-state eDRX cycle, the paging message according to the first cycle in response to determining that the idle-state eDRX cycle of the UE is configured to be beyond a preset multiple of the first cycle;
monitoring the paging message according to the first cycle within a paging time window (PTW) of an idle-state eDRX cycle in response to determining that the idle-state eDRX cycle of the UE is configured to be beyond a preset multiple of the first cycle;
monitoring the paging message according to a shortest one of a second cycle, a third cycle, and a fourth cycle within a paging time window (PTW) of the idle-state eDRX cycle in response to determining that the idle-state eDRX cycle of the UE is configured to be beyond a preset multiple of the first cycle; or
monitoring the paging message according to a shortest one of the first cycle, a third cycle, and a fourth cycle within a paging time window (PTW) of the idle-state eDRX cycle in response to determining that the idle-state eDRX cycle of the UE is configured to be beyond a preset multiple of the first cycle,
where the second cycle is an RAN paging cycle, the third cycle is a core network (CN) paging cycle, and the fourth cycle is a default cycle.

In a case that the idle-state eDRX cycle configured by the network for the UE is not the first cycle and is within a preset multiple of the first cycle, the paging message is monitored according to the first cycle. In this way, even if the core network has CN paging under abnormal circumstances during the UE is in the inactive state, the CN paging can be successfully monitored since the UE monitors a paging message according to the first cycle.

In an example, the preset multiple includes, but is not limited to, 4. In a case that the preset multiple is 4, no PTW is set in the idle-state eDRX cycle, and the UE monitors the CN paging according to the idle-state eDRX cycle. Since the idle-state eDRX cycle is a multiple of the first cycle, the UE monitors a paging message according to the first cycle, and can monitor both the paging message corresponding to the RAN paging and the paging message corresponding to the CN paging.

In a case that the idle-state eDRX cycle is beyond the preset multiple of the first cycle, a PTW may be set in the idle-state eDRX cycle in this case, and the paging message corresponding to the CN paging is issued in the PTW. Considering this situation, in order to make the inactive-state UE successfully monitor the paging message corresponding to the RAN paging and also successfully monitor the paging message corresponding to the CN paging of the core network under abnormal conditions, outside the PTW, the UE may monitor the paging message corresponding to the RAN paging only according to the first cycle, and within the PTW, the UE may further comprehensively consider how to monitor, for example, the UE may determine a cycle to monitor the paging message by balancing the power consumption of the UE and a monitoring success rate of the paging message.

In an example, in a case that the first cycle is the minimum eDRX cycle of the eDRX mode, duration of the first cycle is short, that is, the latency of the reachability of the UE is short. Considering that the UE is not successfully paged, the network will continue to issue a paging message, and even within the PTW, the paging message may be monitored according to the first cycle.

In another example, considering an emergency service at the network, a paging message is monitored according to a shortest one of the second cycle, the third cycle and the fourth cycle within the PTW of the idle-state eDRX cycle, such that it is guaranteed that the latency of the reachability of the UE is minimized.

The second cycle may be a RAN paging cycle. The RAN paging cycle may be generally configured as a cycle for the network to send a paging message corresponding to the RAN paging. The third cycle is a CN paging cycle. The CN paging cycle may be a cycle configured by the network and configured to issue a paging message corresponding to the CN paging. The fourth cycle is a default cycle preconfigured or specified by a network protocol. The default cycle may be a paging cycle used by default in a case that the paging cycle is not agreed between the UE and the network.

Accordingly, a paging message is monitored according to the shortest one of the second cycle, the third cycle and the fourth cycle, such that the UE may monitor the paging message at any position where the paging message may be issued at the network.

In another example, considering an emergency service at the network, a paging message is monitored according to a shortest one of the first cycle, the third cycle and the fourth cycle within the PTW of the idle-state eDRX cycle, such that it is guaranteed that the latency of the reachability of the UE is minimized.

The second cycle is a RAN paging cycle, and the inactive-state eDRX cycle of the current eDRX mode is the first cycle, in this case, the base station is more likely to issue a paging message of RAN paging according to the first cycle. Duration of a RAN paging cycle is generally millisecond level. Monitoring a paging message according to the shortest one of the first cycle, the third cycle and the fourth cycle may prolong a cycle of the UE monitoring the paging message, such that it is guaranteed that the UE monitors the paging message with a highest possible success rate, moreover, unnecessary monitoring is reduced, and power consumption of the UE is reduced.

In some examples, monitoring the paging message according to the first cycle within the paging time window (PTW) of the idle-state eDRX cycle in response to determining that the idle-state eDRX cycle of the UE is configured to be beyond the preset multiple of the first cycle includes: monitoring the paging message according to the first cycle within the paging time window (PTW) of the idle-state eDRX cycle in response to determining that the idle-state eDRX cycle of the UE is configured to be beyond the preset multiple of the first cycle and the base station supports the first cycle.

That is, the base station supports issuing the paging message by using the first cycle as the eDRX cycle, and the UE may monitor the paging message directly according to the first cycle within the PTW of the idle-state eDRX cycle, otherwise, the UE does not need to monitor the paging message directly according to the first cycle.

In an example, monitoring the paging message according to a shortest one of the second cycle, the third cycle, and the fourth cycle within the paging time window (PTW) of the idle-state eDRX cycle in response to determining that the idle-state eDRX cycle of the UE is configured to be beyond the preset multiple of the first cycle includes: monitoring the paging message according to the shortest one of the second cycle, the third cycle, and the fourth cycle within the paging time window (PTW) of the idle-state eDRX cycle in response to determining that the idle-state eDRX cycle of the UE is configured to be beyond the preset multiple of the first cycle and the base station does not support the first cycle.

In a case that the base station does not support the first cycle as the eDRX cycle, it indicates that the base station does not page a message without configuring the RAN paging cycle or the CN paging cycle to be equal to the first cycle. In this case, it may be considered to monitor a paging message according to the shortest one of the second cycle, the third cycle and the fourth cycle.

Monitoring the paging message according to a shortest one of the first cycle, the third cycle, and the fourth cycle within the paging time window (PTW) of the idle-state eDRX cycle in response to determining that the idle-state eDRX cycle of the UE is configured to be beyond the preset multiple of the first cycle includes: monitoring the paging message according to the shortest one of the first cycle, the third cycle, and the fourth cycle within the paging time window (PTW) of the idle-state eDRX cycle in response to determining that the idle-state eDRX cycle of the UE is configured to be beyond the preset multiple of the first cycle and the base station does not support the first cycle.

In a case that the base station does not support the first cycle as the eDRX cycle, it indicates that the base station does not page a message without configuring the RAN paging cycle or the CN paging cycle to be equal to the first cycle. In this case, it may be considered to monitor a paging message according to the shortest one of the second cycle, the third cycle and the fourth cycle.

In an example, in any of the examples described above, the first cycle may be 2.56 s.

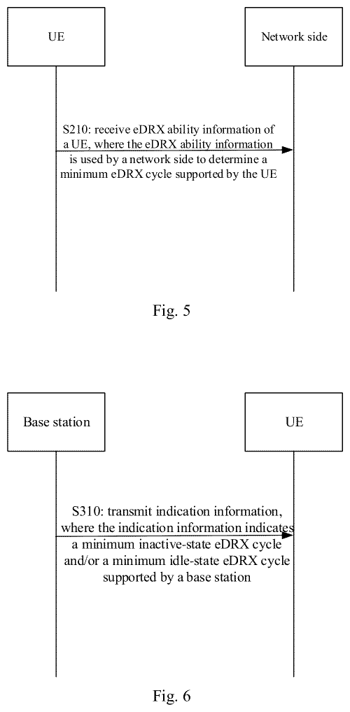

As shown in FIG. 5, an example of the disclosure provides an information processing method. The method is executed by a network device and includes step S210.

Step S210 includes receiving eDRX ability information of a UE, where the eDRX ability information is used by a network to determine a minimum eDRX cycle supported by the UE.

The network device may be a base station of an access network or a core network device of a core network. The core network device includes, but is not limited to, AMF, SMF, or UPF.

The network device receives the eDRX ability information. The eDRX ability information may be used at least for determining the minimum eDRX cycle supported by the UE.

In an example, the eDRX ability information may be used to determine whether the UE supports the minimum eDRX cycle of the eDRX mode. The minimum eDRX cycle supported by the UE is longer than the minimum eDRX cycle of the eDRX mode, it indicates that the UE does not support the minimum eDRX cycle of the eDRX mode. The minimum eDRX cycle supported by the UE is equal to the minimum eDRX cycle of the eDRX mode, it indicates that the UE supports the minimum eDRX cycle of the eDRX mode.

In this way, during the network configures the eDRX cycle for the UE, the eDRX cycle of the UE in at least one of the idle state or the inactive state may be determined according to the eDRX ability information.

In some examples, the eDRX ability information includes at least one of:
first ability information indicating a minimum idle-state eDRX cycle supported by the UE; or
second ability information indicating a minimum inactive-state eDRX cycle supported by the UE.

The first ability information and the second ability information both belong to the eDRX ability information, and may be carried by one piece of message signaling or different pieces of message signaling.

In summary, the first ability information indicates the minimum idle-state eDRX cycle supported by the UE, and the second ability information indicates the minimum inactive-state eDRX cycle supported by the UE.

In an example, the first ability information may be used to determine whether the UE supports the minimum eDRX cycle of the eDRX mode in the idle state. The second ability information may be used to determine whether the UE supports the minimum eDRX cycle of the eDRX mode in the inactive state.

In some examples, the network device is a base station. S210 includes one of the following:
receiving UE ability information indicating the eDRX ability information; or
receiving auxiliary information indicating the eDRX ability information.

The network device is a base station, and the eDRX ability information may be reported in at least one of UE ability information or auxiliary information. In this way, the eDRX ability information is reported without introducing dedicated message signaling, which has strong compatibility with the related art.

Alternatively, in other examples, the eDRX ability information may also be reported to the base station by means of dedicated signaling specially designed. Accordingly, the base station receives the eDRX ability information from the dedicated signaling.

In some examples, the minimum inactive-state eDRX cycle supported by the UE may be used by the base station to configure an inactive-state eDRX cycle for the UE and may also be used for other purposes.

In some examples, the network device is a core network device. Receiving extended discontinuous reception (eDRX) ability information of the UE includes one of the following:
receiving a UE ability information notification indicating the eDRX ability information;
or receiving a non-access stratum (NAS) message indicating the eDRX ability information.

In a case that the network device is a core network device, the eDRX ability information may be carried in the UE ability information notification or the NAS message and reported to the core network device at the network.

In some examples, the minimum idle-state eDRX cycle supported by the UE is used by the core network to configure the idle-state eDRX cycle for the UE.

As shown in FIG. 6, an example of the disclosure provides an information processing method. The method is executed by a base station and further includes step S310.

Step S310 includes transmitting indication information, where the indication information indicates at least one of a minimum inactive-state eDRX cycle or a minimum idle-state eDRX cycle supported by the base station.

The indication information may directly indicate at least one of the minimum inactive-state eDRX cycle or the minimum idle-state eDRX cycle supported by the base station. The method may be executed by the base station alone or in combination with the aforementioned receiving of the eDRX ability information reported by the UE.

In some examples, the indication information may be used by the base station to determine a monitoring cycle for a paging message in combination with at least one of an inactive-state eDRX cycle or an idle-state eDRX cycle of the UE.

In some examples, the indication information is carried in common signaling or dedicated signaling.

Besides 5.12 s, 10.24 s and cycles longer than 10.24 s, a value of 2.56 s is newly added for the eDRX cycle.

An example of the disclosure provides a working mechanism of UE with an eDRX cycle of 2.56 s.

For configuration where the eDRX cycle is 2.56 s, a network configures the eDRX cycle for the UE based on whether the ability of the UE supports the configuration.

The network is informed whether the UE supports the eDRX cycle of 2.56 s.

As an example, the network is informed whether the UE supports the idle-state eDRX cycle of 2.56 s.

As an example, the network is informed whether the UE supports the inactive-state eDRX cycle of 2.56 s.

The base station is informed of the ability of the UE by the following example methods:
reporting the ability of the UE to the base station will be implemented through existing reporting of UE ability; and
reporting the ability of the UE to the base station will be implemented through existing reporting of UE auxiliary information.

The core network is informed of the ability of the UE in the following examples:
the UE ability is reported to the base station, and the base station informs the core network through UE CAPABILITY INFO INDICATION.
the UE informs the core network by means of an NAS message.

The core network configures the UE based on the UE ability. The configuration performed by the core network includes, but is not limited to, configuration of the idle-state eDRX cycle performed by the core network on the UE.

As an example, the core network configures an idle-state eDRX cycle of 2.56 s for the idle-state UE, which is used for monitoring a paging message corresponding to the CN paging.

For configuration where the eDRX cycle is 2.56 s, the UE acts as follows:
as an example, the base station configures an inactive-state eDRX cycle of 2.56 s for the inactive-state UE, which is used for monitoring a paging message corresponding to the RAN paging.

The base station informs the UE of the capability whether to support the eDRX cycle of 2.56 s.

As an example, the UE is informed of the ability whether the base station supports the idle-state eDRX cycle of 2.56 s.

As an example, the UE is informed of the ability whether the base station supports the inactive-state eDRX cycle of 2.56 s.

The UE is informed of the ability of the base station to support the eDRX cycle of 2.56 s through common or dedicated signaling or through protocol pre-agreement. Dedicated signaling used in the dedicated signaling manner includes, but is not limited to, an RRC release message.

As an example, the ability of the base station to support the idle-state eDRX cycle of 2.56 s is preset according to a protocol agreement.

For configuration where the eDRX cycle is 2.56 s, the UE acts as follows:
as an example, in a case that the idle-state UE is configured with an idle-state eDRX cycle of 2.56 s, monitoring of paging is performed according to T=eDRX cycle of 2.56 s; and
as an example, in a case that the inactive-state UE is only configured with an idle-state eDRX cycle of 2.56 s, then:
solution A: monitoring of paging is performed according to the eDRX cycle of 2.56 s.

Further, in some examples, monitoring a paging message according to the eDRX cycle of 2.56 s may be determined according to whether the base station supports an inactive-state eDRX cycle of 2.56 s. For example, in a case that the base station supports the eDRX cycle of 2.56 s, a paging message is monitored directly according to the eDRX cycle of 2.56 s.

In a case that the base station does not support the inactive-state eDRX cycle of 2.56 s, the UE proceeds according to solution B.

Solution B: monitoring of paging is performed according to T: min{eDRX cycle of 2.56 s, RAN paging cycle}.

As an example, in a case that the inactive-state UE is configured with an inactive-state eDRX cycle of 2.56 s, the following manners are performed:
Solution C: in a case that the UE is configured with an idle-state eDRX cycle of 2.56 s, 5.12 s or 10.24 s, monitoring of paging is performed according to the eDRX cycle of 2.56 s;
Solution D: in a case that the UE is configured with an idle-state eDRX cycle longer than 10.24 s, the UE performs monitoring according to the inactive-state eDRX cycle of 2.56 s outside the PTW, and there are two cases within the PTW of the idle-state eDRX cycle.

### Case 1:

Monitoring of paging is performed within the PTW according to T: min{UE-specific cycle, RAN paging cycle, default cycle}. The UE-specific cycle may be considered as an idle-state eDRX cycle of the UE, and the UE-specific cycle may be a paging cycle configured by a non-access stratum.

In some cases, in a case that monitoring of paging is performed according to T: min{UE-specific cycle, RAN paging cycle, default cycle}, the paging cycle, that is, the inactive-state eDRX cycle, may be 2.56 s.

### Case 2:

Monitoring of paging is performed within the PTW according to T: inactive-state eDRX cycle of 2.56 s.

Conditions for using Case 1 and Case 2 could be as follows:
in a case that the base station supports the inactive-state eDRX cycle of 2.56 s, the UE proceeds according to case 2;
in a case that the base station does not support the inactive-state eDRX cycle of 2.56 s, the UE proceeds according to case 1.

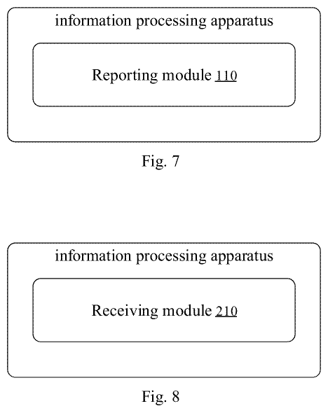

As shown in FIG. 7, an example of the disclosure provides an information processing apparatus. The apparatus includes: a reporting module 110 configured to report extended discontinuous reception (eDRX) ability information of a UE, where the eDRX ability information is used by a network to determine a minimum eDRX cycle supported by the UE.

The information processing apparatus may be applied to the UE.

In some examples, a program module may be used as the reporting module 110. The reporting module 110 may be used by the UE to report the eDRX ability information. The eDRX ability information may be at least used by the network to determine the minimum eDRX cycle supported by the UE. Thus, the network knows whether the UE supports the minimum eDRX cycle of a eDRX mode.

In another example, the reporting module 110 may be a hardware-software combination module. The hardware-software combination module includes, but is not limited to, various programmable arrays. The programmable arrays include, but are not limited to, at least one of complex programmable arrays or field programmable arrays.

In yet another example, the reporting module 110 may further include a pure hardware module. The pure hardware module includes, but is not limited to, various application specific integrated circuits.

In an example, the eDRX ability information includes at least one of:
first ability information indicating a minimum idle-state eDRX cycle supported by the UE; or
second ability information indicating a minimum inactive-state eDRX cycle supported by the UE.

In an example, the reporting module 110 is configured to report UE ability information indicating the eDRX ability information to a base station; and alternatively, to report auxiliary information indicating the eDRX ability information to the base station.

In an example, the minimum inactive-state eDRX cycle supported by the UE is used by the base station to configure an inactive-state eDRX cycle for the UE.

In an example, the reporting module 110 is configured to report a UE ability information notification indicating the eDRX ability information to a core network; and alternatively, to report a non-access stratum (NAS) message indicating the eDRX ability information to a core network.

In an example, the minimum idle-state eDRX cycle supported by the UE is used by the core network to configure an idle-state eDRX cycle for the UE.

In an example, the apparatus further includes: a determination module configured to determine a minimum eDRX cycle supported by a base station.

In an example, the determination module is configured to execute one of the following:
receiving indication information, where the indication information indicates at least one of a minimum inactive-state eDRX cycle or a minimum idle-state eDRX cycle supported by the base station; and
determining at least one of the minimum inactive-state eDRX cycle or the minimum idle-state eDRX cycle supported by the base station according to a protocol agreement.

In an example, the indication information is carried in common signaling or dedicated signaling.

In an example, the apparatus further includes a monitoring module.

The monitoring module is configured to monitor, in response to determining that the UE is in an idle state and an idle-state eDRX cycle is configured as a first cycle, a paging message according to the first cycle, where the first cycle is a minimum eDRX cycle of an eDRX mode; alternatively, to monitor, in response to determining that the UE is in an inactive state, an idle-state eDRX cycle of the UE is configured as a first cycle and an inactive-state eDRX cycle is not configured as the first cycle, a paging message according to the first cycle; alternatively, to monitor, in response to determining that the UE is in an inactive state, an idle-state eDRX cycle of the UE is configured as a first cycle and an inactive-state eDRX cycle is not configured as the first cycle, a paging message according to a shorter one of the first cycle and a second cycle; alternatively, to monitor, in response to determining that the UE is in an inactive state, an idle-state eDRX cycle of the UE is configured as a first cycle, and an inactive-state eDRX cycle is not configured as the first cycle, a paging message according to the minimum inactive-state eDRX cycle supported by the base station; and alternatively, to monitor, in response to determining that the UE is in an inactive state and an inactive-state eDRX cycle of the UE is configured as a first cycle, a paging message according to an idle-state eDRX cycle configured for the UE by a network.

In an example, the monitoring module is configured to monitor, in response to determining that the base station supports an inactive-state eDRX cycle as the first cycle, the paging message according to the first cycle; and alternatively, to monitor, in response to determining that the base station does not support an inactive-state eDRX cycle as the first cycle, the paging message according to a shorter one of the first cycle and the second cycle, where the second cycle is a radio access network (RAN) paging cycle.

In an example, monitoring the paging message according to the idle-state eDRX cycle of the UE includes one of the following:
monitoring the paging message according to the first cycle in response to determining that the idle-state eDRX cycle of the UE is configured to be within a preset multiple of the first cycle;
monitoring the paging message according to the first cycle outside a paging time window (PTW) of the idle-state eDRX cycle in response to determining that the idle-state eDRX cycle of the UE is configured to be beyond a preset multiple of the first cycle;
monitoring the paging message according to the first cycle within a paging time window (PTW) of the idle-state eDRX cycle in response to determining that the idle-state eDRX cycle of the UE is configured to be beyond a preset multiple of the first cycle;
monitoring the paging message according to a shortest one of a second cycle, a third cycle, and a fourth cycle within a paging time window (PTW) of the idle-state eDRX cycle in response to determining that the idle-state eDRX cycle of the UE is configured to be beyond a preset multiple of the first cycle; or
monitoring the paging message according to a shortest one of the first cycle, a third cycle, and a fourth cycle within a paging time window (PTW) of the idle-state eDRX cycle in response to determining that the idle-state eDRX cycle of the UE is configured to be beyond a preset multiple of the first cycle;
where the second cycle is an RAN paging cycle, the third cycle is a core network (CN) paging cycle, and the fourth cycle is a default cycle.

In an example, the monitoring module is configured to monitor the paging message according to the first cycle inside the paging time window (PTW) of the idle-state eDRX cycle in response to determining that the idle-state eDRX cycle of the UE is configured to be beyond a preset multiple of the first cycle and the base station supports the first cycle.

In an example, the paging module is configured to monitor the paging message according to a shortest one of a second cycle, a third cycle, and a fourth cycle within the paging time window (PTW) of the idle-state eDRX cycle in response to determining that the idle-state eDRX cycle of the UE is configured to be beyond a preset multiple of the first cycle and the base station does not support the first cycle.

Alternatively, the paging module is configured to monitor the paging message according to a shortest one of the first cycle, a third cycle, and a fourth cycle within the paging time window (PTW) of the idle-state eDRX cycle in response to determining that the idle-state eDRX cycle of the UE is configured to be beyond a preset multiple of the first cycle and the base station does not support the first cycle.

In an example, the first cycle is 2.56 s.

As shown in FIG. 8, an example of the disclosure provides an information processing apparatus. The apparatus includes: a receiving module 210 configured to receive eDRX ability information of a UE, where the eDRX ability information is used by a network to determine a minimum eDRX cycle supported by the UE.

The information processing apparatus may be applied to a network device. The network device may be a base station or a core network device.

In some examples, the receiving module 210 may be a program module. The receiving module 210 may be used by the network to receive the eDRX ability information. The eDRX ability information may be at least used by the network to determine the minimum eDRX cycle supported by the UE. In this way, the network knows whether the UE supports the minimum eDRX cycle of the eDRX mode.

In another example, the receiving module 210 may be a hardware-software combination module. The hardware-software combination module includes, but is not limited to, various programmable arrays. The programmable arrays include, but are not limited to, at least one of complex programmable arrays or field programmable arrays.

In yet another example, the receiving module 210 may further includes a pure hardware module. The pure hardware module includes, but is not limited to, various application specific integrated circuits.

In some examples, the eDRX ability information includes at least one of:
first ability information indicating a minimum idle-state eDRX cycle supported by the UE; or
second ability information indicating a minimum inactive-state eDRX cycle supported by the UE.

In some examples, the network device is a base station. The receiving module 210 is configured to receive UE ability information indicating the eDRX ability information; and alternatively, to receive auxiliary information indicating the eDRX ability information.

In some examples, the minimum inactive-state eDRX cycle supported by the UE is used by the base station to configure an inactive-state eDRX cycle for the UE.

In some examples, the network device is a core network device. The receiving module 210 is configured to receive a UE ability information notification indicating the eDRX ability information; and alternatively, to receive a non-access stratum (NAS) message indicating the eDRX ability information.

In some examples, the minimum idle-state eDRX cycle supported by the UE is used by the core network to configure an idle-state eDRX cycle for the UE.

In some examples, the network device is a base station. The apparatus further includes:

a transmission module configured to transmit indication information, where the indication information indicates at least one of a minimum inactive-state eDRX cycle or a minimum idle-state eDRX cycle supported by the base station.

In some examples, the indication information is carried in common signaling or dedicated signaling.

An example of the disclosure provides a communication device. The communication device includes: a memory configured to store a processor executable instruction; and a processor connected to the memory; where the processor is configured to execute the information processing method provided in any of the foregoing technical solutions.

The processor may include various types of storage media that are non-transitory computer storage media capable of continuing to memorize the information stored in the processor after the communication device is powered down.

The communication device includes an access device, UE, or a core network device.

The processor may be connected to the memory by means of a bus, etc. for reading an executable program, for example, at least one of methods as shown in FIGS. 4-5, stored in the memory.

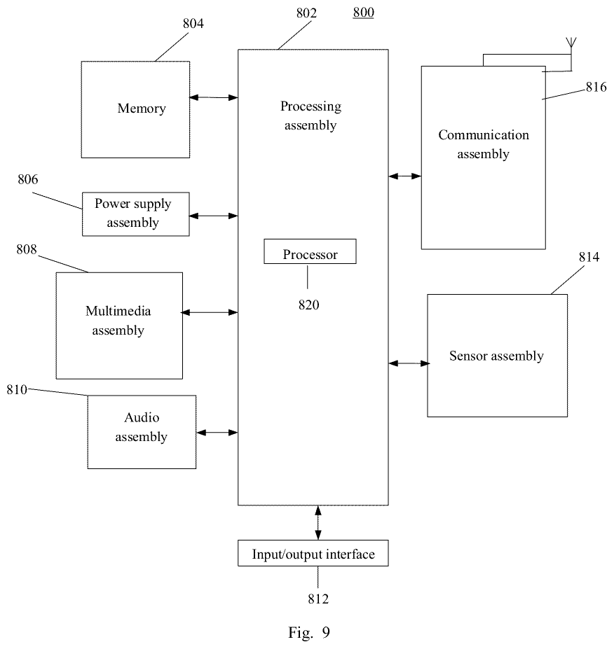

FIG. 9 is a block diagram of UE 800 according to an example. For example, the UE 800 may be a mobile phone, a computer, a digital broadcast user equipment, a messaging device, a gaming console, a tablet device, a medical device, a fitness device, a personal digital assistant, etc.

With reference to FIG. 9, the UE 800 may include one or more of a processing assembly 802, a memory 804, a power supply assembly 806, a multimedia assembly 808, an audio assembly 810, an input/output (I/O) interface 812, a sensor assembly 814, and a communication assembly 816.

The processing assembly 802 generally controls overall operation of the UE 800, for example, operation associated with display, phone calls, data communications, camera operations, and recording operations. The processing assembly 802 may include one or more processors 820 to execute an instruction to complete all or some of the steps of the method above. Moreover, the processing assembly 802 may include one or more modules to facilitate interaction between the processing assembly 802 and other assemblies. For example, the processing assembly 802 may include a multimedia module to facilitate interaction between the multimedia assembly 808 and the processing assembly 802.

The memory 804 is configured to store various types of data to support operation on the UE 800. Instances of such data include an instruction, operated on the UE 800, for any application or method, contact data, phonebook data, messages, pictures, video, etc. The memory 804 may be implemented by any types of volatile or non-volatile memory apparatus, or their combination, for instance, a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply assembly 806 supplies power to the various assemblies of the UE 800. The power supply assembly 806 may include a power management system, one or more power supplies, and other assemblies associated with power generation, management, and distribution for the UE 800.

The multimedia assembly 808 includes a screen that provides an output interface between the UE 800 and the user. In some examples, the screen may include a liquid crystal display (LCD) and a touch panel (TP). In a case that the screen includes a touch panel, the screen may be implemented as a touch screen, so as to receive an input signal from a user. The touch panel includes one or more touch sensors to sense touches, slides, and gestures on the touch panel. The touch sensor may not only sense a boundary of a touch or slide action, but also detect duration and pressure related to the touch or slide operation. In some examples, the multimedia assembly 808 includes a front-facing camera and/or a rear-facing camera. When the UE 800 is in an operational mode, for instance, a photographing mode or a video mode, the front-facing camera and/or the rear-facing camera may receive external multimedia data. Each of the front-facing camera and the rear-facing camera may be a fixed optical lens system or have a focal length and optical zoom capability.

The audio assembly 810 is configured to output and/or input audio signals. For example, the audio assembly 810 includes a microphone (MIC) configured to receive an external audio signal when the UE 800 is in operational modes, such as a call mode, a recording mode, and a speech recognition mode. The received audio signal may be further stored in the memory 804 or transmitted via the communication assembly 816. In some examples, the audio assembly 810 further includes a speaker for outputting an audio signal.

The I/O interface 812 provides an interface between the processing assembly 802 and a peripheral interface module, which may be a keyboard, a click wheel, a button, etc. These buttons may include, but are not limited to, a home button, a volume button, a start button, and a lock button.

The sensor assembly 814 includes one or more sensors for providing state assessments of various aspects of the UE 800. For example, the sensor assembly 814 may detect an on/off state of the UE 800 and relative positioning of the assemblies. For instance, the assemblies are a display and a keypad of the UE 800. The sensor assembly 814 may also detect a change in position of the UE 800 or an assembly of the UE 800, the presence or absence of contact between the user and the UE 800, orientation or acceleration/deceleration of the UE 800, and temperature variation of the UE 800. The sensor assembly 814 may include a proximity sensor configured to detect the presence of a nearby object in the absence of any physical contact. The sensor assembly 814 may also include a light sensor, for instance, a complementary metal oxide semiconductor (CMOS) or charge coupled device (CCD) image sensor, for use in imaging applications. In some examples, the sensor assembly 814 may further include an acceleration sensor, a gyroscope sensor, a magnetic sensor, a pressure sensor, or a temperature sensor.

The communication assembly 816 is configured to facilitate wired or wireless communication between the UE 800 and other devices. The UE 800 may access a wireless network based on a communication standard, such as WiFi, 2G, or 3G, or a combination of them. In an example, the communication assembly 816 receives a broadcast signal or broadcast related information from an external broadcast management system by means of a broadcast channel. In an example, the communication assembly 816 also includes a near field communication (NFC) module to facilitate short-range communication. For instance, the NFC module may be implemented based on a radio frequency identification (RFID) technology, an infrared data association (IrDA) technology, an ultra wide band (UWB) technology, a Bluetooth (BT) technology, or other technologies.

In an example, the UE 800 may be implemented by one or more application specific integrated circuits (ASICs), a digital signal processor (DSP), a digital signal processing device (DSPD), a programmable logic device (PLD), a field programmable gate array (FPGA), a controller, a microcontroller, a microprocessor, or other electronic elements for executing the method above.

In an example, further provided is a non-transitory computer-readable storage medium including instructions, for instance, a memory 804 including instructions which are executable by a processor 820 of UE 800, to complete the methods above. For instance, the non-transitory computer-readable storage medium may be a read-only memory (ROM), a random access memory (RAM), a compact disc read-only memory (CD-ROM), a magnetic tape, a floppy disk, an optical data storage apparatus, etc.

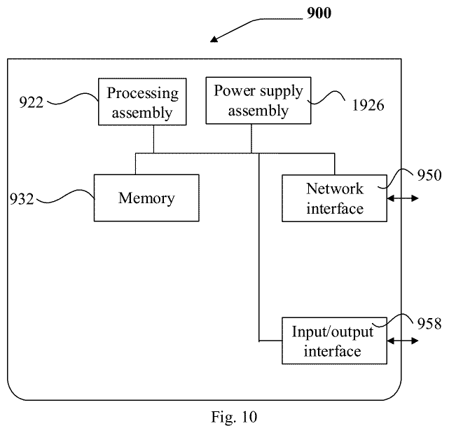

As shown in FIG. 10, an example of the disclosure shows a structure of an communication device. For example, the communication device 900 may be provided as a network device. The communication device 900 may be the foregoing access device and/or core network device. The typical access device includes, but is not limited to, a base station.

With reference to FIG. 10, the communication device 900 includes a processing assembly 922, which further includes one or more processors, and memory resources represented by a memory 932 for storing an instruction executable by the processing assembly 922, for example, an application program. The application program stored in the memory 932 may include one or more modules, each of which corresponds to a set of instructions. Moreover, the processing assembly 922 is configured to execute an instruction, so as to execute any of the above methods applied to the access device, for example, the method shown in FIGS. 3-6.

The communication device 900 may further include a power supply assembly 926 configured to execute power supply management of the communication device 900, a wired or wireless network interface 950 configured to connect the communication device 900 to a network, and an input/output (I/O) interface 958. The communication device 900 may operate an operating system stored in the memory 932, such as Windows Server™, Mac OS X™, Unix™, Linux™, FreeBSD™, etc.

According to the technical solutions provided in the examples of the disclosure, eDRX UE reports the eDRX ability information, such that the network can configure the eDRX cycle for the UE according to the minimum eDRX cycle supported by the UE. A phenomenon that the UE does not support the eDRX cycle due to improper configuration of the eDRX cycle or a phenomenon that the UE monitors a paging message too frequently causing larger power consumption due to improper configuration of the eDRX cycle are reduced, and the power consumption of the UE is reduced.

Those skilled in the art can readily conceive of other embodiments of the disclosure upon consideration of the specification and practice of the disclosure. The disclosure is intended to cover any variations, uses, or adaptive changes of the disclosure, and these variations, uses, or adaptive changes follow general principles of the disclosure and include common general knowledge or customary technical means in the technical field not disclosed in the disclosure. The specification and embodiments are considered as illustrative merely, and a true scope and spirit of the disclosure are indicated by the following claims.

It should be understood that the disclosure is not limited to the precise structure that has been described above and shown in the accompanying drawings and can be modified and altered in various ways without departing from its scope. The scope of the disclosure is limited only by the appended claims.

1. An information processing method, executed by a user equipment (UE), and comprising:
reporting extended discontinuous reception (eDRX) ability information of the UE, wherein the eDRX ability information is used by a network to determine a minimum eDRX cycle supported by the UE.

2. The method according to claim 1, wherein the eDRX ability information comprises at least one of:
first ability information indicating a minimum idle-state eDRX cycle supported by the UE;
or,
second ability information indicating a minimum inactive-state eDRX cycle supported by the UE.

3. The method according to claim 1, wherein reporting the extended discontinuous reception (eDRX) ability information of the UE comprises: reporting UE ability information indicating the eDRX ability information to a base station; or reporting auxiliary information indicating the eDRX ability information to the base station;
or
wherein reporting the extended discontinuous reception (eDRX) ability information of the UE comprises: reporting a UE ability information notification indicating the eDRX ability information to a core network; or, reporting a non-access stratum (NAS) message indicating the eDRX ability information to the core network.

4. The method according to claim 3, wherein a minimum inactive-state eDRX cycle supported by the UE is used by the base station to configure an inactive-state eDRX cycle for the UE;
or
wherein a minimum idle-state eDRX cycle supported by the UE is used by the core network to configure an idle-state eDRX cycle for the UE.

5-6. (canceled)

7. The method according to claim 1, further comprising:
determining a minimum eDRX cycle supported by a base station.

8. The method according to claim 7, wherein determining the minimum eDRX cycle supported by the base station comprises one of:
receiving indication information, wherein the indication information indicates at least one of a minimum inactive-state eDRX cycle or a minimum idle-state eDRX cycle supported by the base station; or
determining at least one of a minimum inactive-state eDRX cycle or a minimum idle-state eDRX cycle supported by the base station according to a protocol agreement.

9. The method according to claim 8, wherein the indication information is carried in common signaling or dedicated signaling.

10. The method according to claim 1, further comprising:
monitoring, in response to determining that the UE is in an idle state and an idle-state eDRX cycle is configured as a first cycle, a paging message according to the first cycle, wherein the first cycle is a minimum eDRX cycle of an eDRX mode;
or,
monitoring, in response to determining that the UE is in an inactive state, an idle-state eDRX cycle of the UE is configured as a first cycle and an inactive-state eDRX cycle is not configured as the first cycle, a paging message according to the first cycle;
or,
monitoring, in response to determining that the UE is in an inactive state, an idle-state eDRX cycle of the UE is configured as a first cycle and an inactive-state eDRX cycle is not configured as the first cycle, a paging message according to a shorter one of the first cycle and a second cycle;
or,
monitoring, in response to determining that the UE is in an inactive state, an idle-state eDRX cycle of the UE is configured as a first cycle, and an inactive-state eDRX cycle is not configured as the first cycle, a paging message according to a minimum inactive-state eDRX cycle supported by a base station;
or,
monitoring, in response to determining that the UE is in an inactive state and an inactive-state eDRX cycle of the UE is configured as a first cycle, a paging message according to an idle-state eDRX cycle configured for the UE by a network.

11. The method according to claim 10, wherein monitoring the paging message according to the minimum inactive-state eDRX cycle supported by the base station comprises:
monitoring, in response to determining that the base station supports an inactive-state eDRX cycle as the first cycle, the paging message according to the first cycle;
or,
monitoring, in response to determining that the base station does not support an inactive-state eDRX cycle as the first cycle, the paging message according to a shorter one of the first cycle and a second cycle, wherein the second cycle is a radio access network (RAN) paging cycle.

12. The method according to claim 10, wherein monitoring the paging message according to the idle-state eDRX cycle configured for the UE by the network comprises:
monitoring the paging message according to the first cycle in response to determining that the idle-state eDRX cycle of the UE is configured to be within a preset multiple of the first cycle;
or,
monitoring the paging message according to the first cycle outside a paging time window (PTW) of the idle-state eDRX cycle in response to determining that the idle-state eDRX cycle of the UE is configured to be beyond a preset multiple of the first cycle;
or,
monitoring the paging message according to the first cycle within a paging time window (PTW) of the idle-state eDRX cycle in response to determining that the idle-state eDRX cycle of the UE is configured to be beyond a preset multiple of the first cycle;
or,
monitoring the paging message according to a shortest one of a second cycle, a third cycle, and a fourth cycle within a paging time window (PTW) of the idle-state eDRX cycle in response to determining that the idle-state eDRX cycle of the UE is configured to be beyond a preset multiple of the first cycle; and
or,
monitoring the paging message according to a shortest one of the first cycle, the third cycle, and the fourth cycle within a paging time window (PTW) of the idle-state eDRX cycle in response to determining that the idle-state eDRX cycle of the UE is configured to be beyond a preset multiple of the first cycle;
wherein the second cycle is a radio access network (RAN) paging cycle, the third cycle is a core network (CN) paging cycle, and the fourth cycle is a default cycle.

13. The method according to claim 12, wherein monitoring the paging message according to the first cycle within the paging time window (PTW) of the idle-state eDRX cycle in response to determining that the idle-state eDRX cycle of the UE is configured to be beyond the preset multiple of the first cycle comprises: monitoring the paging message according to the first cycle within the paging time window (PTW) of the idle-state eDRX cycle in response to determining that the idle-state eDRX cycle of the UE is configured to be beyond the preset multiple of the first cycle and the base station supports the first cycle;
or
monitoring the paging message according to a shortest one of the second cycle, the third cycle, and the fourth cycle within the paging time window (PTW) of the idle-state eDRX cycle in response to determining that the idle-state eDRX cycle of the UE is configured to be beyond the preset multiple of the first cycle comprises:
monitoring the paging message according to the shortest one of the second cycle, the third cycle, and the fourth cycle within the paging time window (PTW) of the idle-state eDRX cycle in response to determining that the idle-state eDRX cycle of the UE is configured to be beyond the preset multiple of the first cycle and the base station does not support the first cycle;
or
monitoring the paging message according to the shortest one of the first cycle, the third cycle, and the fourth cycle within the paging time window (PTW) of the idle-state eDRX cycle in response to determining that the idle-state eDRX cycle of the UE is configured to be beyond the preset multiple of the first cycle comprises: monitoring the paging message according to the shortest one of the first cycle, the third cycle, and the fourth cycle within the paging time window (PTW) of the idle-state eDRX cycle in response to determining that the idle-state eDRX cycle of the UE is configured to be beyond the preset multiple of the first cycle and the base station does not support the first cycle.

14. (canceled)

15. The method according to claim 10, wherein the first cycle is 2.56 s.

16. An information processing method, executed by a network device, and comprising:
receiving extended discontinuous reception (eDRX) ability information of a UE, wherein the eDRX ability information is used by a network to determine a minimum eDRX cycle supported by the UE.

17. The method according to claim 16, wherein the eDRX ability information comprises at least one of:
first ability information indicating a minimum idle-state eDRX cycle supported by the UE;
or,
second ability information indicating a minimum inactive-state eDRX cycle supported by the UE.

18. The method according to claim 16, wherein the network device is a base station, and receiving the extended discontinuous reception (eDRX) ability information of the UE comprises: receiving UE ability information indicating the eDRX ability information; or, receiving auxiliary information indicating the eDRX ability information;
or
wherein the network device is a core network device, and receiving the extended discontinuous reception (eDRX) ability information of the UE comprises: receiving a UE ability information notification indicating the eDRX ability information; or, receiving a non-access stratum (NAS) message indicating the eDRX ability information.

19. The method according to claim 18, wherein a minimum inactive-state eDRX cycle supported by the UE is used by the base station to configure an inactive-state eDRX cycle for the UE;
or
wherein a minimum idle-state eDRX cycle supported by the UE is used by the core network device to configure an idle-state eDRX cycle for the UE.

20-21. (canceled)

22. The method according to claim 16, wherein the network device is a base station, and the method further comprises:
transmitting indication information, wherein the indication information indicates at least one of a minimum inactive-state eDRX cycle and/or a minimum idle-state eDRX cycle supported by the base station.

23. The method according to claim 22, wherein the indication information is carried in common signaling or dedicated signaling.

24-29. (canceled)

30. A communication device, comprising:
a processor,
a transceiver,
a memory, and
an executable program stored in the memory and executable by the processor, wherein the executable program when executed by the processor causes the processor to execute a method comprising:
reporting extended discontinuous reception (eDRX) ability information of a UE, wherein the eDRX ability information is used by a network to determine a minimum eDRX cycle supported by the UE.

31. (canceled)

32. A communication device, comprising:
a processor,
a transceiver,
a memory, and
an executable program stored in the memory,
wherein the executable program when executed by the processor causes the processor to execute the method according to claim 16.
